(19) United States
(12) Patent Application Publication
(10) Pub. No.: US 2026/0280162 A1
(43) Pub. Date: Sep. 17, 2026

(54) ELECTRICAL INTERFACE

(71) Applicant: TE Connectivity Solutions GmbH, Schaffhausen (CH)

(72) Inventors: Frank FLITTNER, Bensheim (DE); Dominik KLINGLER, Bensheim (DE); Gregor KARRASCH, Bensheim (DE); Felix BAUER, Bensheim (DE); Alfons KETTELER, Bensheim (DE); Matthew Steven HOUSER, Middletown, PA (US)

(21) Appl. No.: 19/562,967

(22) Filed: Mar. 11, 2026

(30) Foreign Application Priority Data
Mar. 11, 2025 (EP) 25163058.8

(51) Int. Cl. H01R 12/70; H01R 12/58; H01R 12/71; H01R 13/05; H01R 13/6595

(52) U.S. Cl. CPC H01R 12/7064; H01R 12/58; H01R 12/716; H01R 13/052; H01R 13/6595

(57) ABSTRACT

An electrical interface includes a first housing having a chamber extending at least between a first opening arranged at a mating end of the first housing, and a second opening arranged at a bottom end of the first housing. The mating end is configured to receive a corresponding electrical plug connector. The electrical interface includes at least one electrical contact extending within the chamber at least between the mating end and the bottom end and is configured to electrically connect to corresponding plug contacts of the plug assembly. The electrical interface includes a shielding assembly having a first end configured to be mounted to a printed circuit board, and a second end configured to slidably engage within the bottom end of the first housing.

### CROSS REFERENCE TO RELATED APPLICATIONS

This application claims the benefit of EP Application No. 25163058.8, filed 11 Mar. 2025, the subject matter of which is herein incorporated by reference in its entirety.

### BACKGROUND OF THE INVENTION

The present disclosure relates to an electrical interface, and in particular to a surface-mount data connectivity header, and to a method of mounting a header to a printed circuit board (PCB).

Data connectivity interfaces for PCB are known in the art and are often referred to as headers. Typically, such headers include a die-cast housing which accommodates the electrical contacts and defines the mating geometry for interconnection with a corresponding plug assembly. In the prior art, the process of mounting such headers to the PCB includes soldering the header to soldering pads arranged on the PCB, which implies unwanted limitations of the header design. For example, in cases where the soldering is performed in a soldering furnace, the header is exposed to high temperatures, which effectively limits material choices for certain components of the header such as its internal electrical insulation. The process also puts constraints on the measurements of the header, for instance due to limited height of the interior of the furnace. Further boundary conditions of this process relate to the placement of the header on the PCB prior to soldering, as the header has to be designed such that its center of gravity lies within an area circumscribed by the soldering contacts, or the header may topple over during soldering.

### BRIEF DESCRIPTION OF THE INVENTION

In one embodiment, it is an object of the present disclosure to provide an electrical interface for an electrical connection that overcomes or at least mitigates the shortcomings of the prior art, or at least provides the public with a convenient alternative.

In one embodiment, it is an object of the present disclosure to provide a method of mounting an electrical interface to a PCB.

The objects are achieved by an electrical interface and by a method defined in the claims.

According to a first aspect, the present disclosure provides an electrical interface, preferably a data connectivity header, the electrical interface comprising: a first housing comprising: a chamber extending at least between a first opening arranged at a mating end of the first housing, and a second opening arranged at a bottom end of the first housing; the mating end configured to receive a corresponding electrical plug connector; at least one electrical contact extending within the chamber at least between the mating end and the bottom end, the at least one electrical contact being configured to electrically connect to corresponding plug contacts of the plug assembly; a shielding assembly comprising a first end configured to be mounted to a printed circuit board, and a second end configured to slidably engage within the bottom end of the first housing.

The shielding assembly of the electrical interface defined in the above serves multiple purposes. One of these purposes is to facilitate the mounting of the electrical interface to the PCB. As will be appreciated, the slidable engagement between the first housing and the shielding assembly allows the first housing to be mounted to the shielding assembly before the latter is mounted to the PCB, and after.

This means that in cases in which the shielding assembly is mounted to the PCB using a soldering process, the mounting of the first housing to the shielding assembly may take place after the soldering process, thus avoiding the requirement to subject the first housing to high temperatures during soldering. This in turn provides greater freedom in the material choices for the first housing.

Another advantage of the option to separately mount the shielding assembly to the PCB resides in a greater freedom of giving the first housing its desired shape. As the soldering may take place without the first housing attached to the shielding assembly as previously stated, it is sufficient to design the shielding assembly such that positioning for soldering is straightforward. In most applications, this goal can easily be achieved. Once soldering is done, the shielding assembly stabilizes the first housing as soon as the slidable engagement between the two parts is effected. Due to this mechanical connection, there is not requirement for the center of gravity of the first housing to be within the boundaries of the soldering area on the PCB, and a variety of elongate and cantilever geometries of the first housing are possible without the need for stabilization of the structure during the soldering process.

Further, the electrical interface defined in the above allows for selective material selection for the shielding assembly and the first housing. In other words, each of these two components may be optimized for their respective purposes, without the need of making compromises. In configurations of the electrical interface, the shielding assembly is optimized for the tasks of providing electrical shielding and mounting properties, while the first housing is optimized with a view to shielding properties and formability, to take account of e.g. the requirement of providing a desired mating geometry at a certain cost. In these configurations, the slidable engagement between the first housing and the shielding assembly may provide for good electrical conductivity.

Another advantage of the electrical interface defined above resides in the possibility of removing and/or replacing parts of the electrical interface, for example the first housing, without the requirement to dismount it from the PCB. Damages to the PCB may therefore be avoided.

The second opening of the first housing may be configured to receive the second end of the shielding assembly in a press-fit manner. This feature may improve both mechanical robustness and electrical conductivity of the connection.

The shielding assembly may comprise a closed circumferential wall extending between the first end and the second end. This allows for enhanced electrical shielding properties in configurations in which the at least one electrical contact is encompassed by the shielding assembly. It also enhances robustness of the connection between the PCB, the shielding assembly, and the first housing.

The shielding assembly may comprise at least one protrusion embossed in the circumferential wall, the at least one protrusion being configured to mechanically engage with a corresponding at least one surface of the bottom end to establish a press-fit contact.

The first housing may comprise at least one protrusion in at least one surface of the bottom end, the at least one protrusion being configured to mechanically engage with the circumferential wall of the shielding assembly, to establish a press-fit contact.

The shape and size of the protrusions may be varied to provide for a desired retaining force between the shielding assembly and the first housing.

For additional mechanical robustness of the connection between the first housing and the shielding assembly, the first housing may be mechanically fastened to the shielding assembly in addition to the slidable engagement. In configurations of the electrical interface, it is subject to a coining process after assembly of the first housing to the shielding assembly, in which process opposing side walls of the first housing are depressed towards the shielding assembly with a pointy tool once the shielding assembly is inserted into the second opening.

The shielding assembly may comprise a soldering skirt extending from the first end of the circumferential wall, the soldering skirt configured to extend parallel to a mounting surface of the PCB and to be soldered to corresponding soldering contacts of the PCB.

The soldering skirt may extend at substantially 90 degrees from the first end of the circumferential wall.

The shielding assembly may comprise at least one, preferably a plurality of, contact pins extending from the first end and configured for insertion into and frictional engagement with corresponding at least one shielding through holes in the PCB.

Each one of the at least one contact pins may comprise an elastic press-fit portion comprising displaceable contact arms which at least in sections extend in opposite directions from each other.

Each one of the at least one contact pins may extend linearly between a first pin end attached to the circumferential wall of the shielding assembly and a second pin end distal from the first pin end, the press-fit portion extending symmetrical between the first pin end and the second pin end.

The circumferential wall may extend along a substantially rectangular shape, wherein the contact pins are evenly distributed along at least three sides of the circumference of the rectangular shape.

In configurations in which the electrical contacts of the electrical interface are arranged within a circumference of the contact pins, the contact pins may act to protect the electrical contacts during handling of the electrical interface. In some configurations, the parts of the contact pins protruding from the header in the mating direction with the PCB are designed to be longer than the protruding parts of the electrical contacts, thereby providing even more protection during handling and mounting of the electrical interface.

The shielding assembly may comprise at least one spring element extending from the first end of the circumferential wall, the at least one spring element configured to provide a pretension force between the circumferential wall and a mounting surface of the PCB when the electrical interface is mounted to the PCB.

The at least one spring element may comprise a bent portion adjacent the circumferential wall, and a flange portion configured to extend parallel to a mounting surface of the PCB, or perpendicular to the mounting surface.

The electrical interface may comprise a plurality of contact pins and a plurality of spring elements, wherein each spring element is arranged between two contact pins.

The shielding element may be manufactured from one continuous piece of metal, including one or more of the steps of cutting, punching, folding, coining, and bending a metal blank.

The electrical interface may comprise a second housing arranged in the chamber and at least partially enclosing the at least one electrical contact, the second housing being configured to electrically insulate the at least one electrical contact.

In configurations of the electrical interface, the shielding assembly encompasses both the second housing and the shielding assembly. Thereby, the shielding assembly provides a constraint for the second housing, advantageously making additional fastening of the latter to the first housing unnecessary.

According to another aspect, the present disclosure provides a method of mounting an electrical interface to a printed circuit board, comprising the steps of: S1—Providing a first housing comprising a chamber extending at least between a first opening arranged at a mating end of the first housing, and a second opening arranged at a bottom end of the first housing; S2—Providing a shielding assembly comprising a first end configured to be mounted to the PCB, and a second end configured to slidably engage within the bottom end of the first housing; selectively: S3a—Mounting the shielding assembly to the PCB; and S4a—Sliding the first housing onto the shielding assembly; Or S3b—Sliding the first housing onto the shielding assembly; and S4b—Mounting the shielding assembly and the first housing onto the PCB.

As pointed out above in relation to the design of the electrical interface, the method advantageously provides for at least two options to facilitate the mounting: The slidable engagement between the first housing and the shielding assembly allows the first housing to be mounted to the shielding assembly before the latter is mounted to the PCB, and after.

In the method: Step S3a may comprise the step of soldering a soldering area arranged at the first end of the shielding assembly to corresponding soldering pads of the PCB; and/or Step S3a may comprise the step of pressing at least one contact pin provided on the shielding assembly in a corresponding shielding through hole of the PCB.

In the method: Step S3a may comprise the step of pressing at least one contact pin provided on the shielding assembly in a corresponding shielding through hole of the PCB; and/or Step S4b may comprise the step of soldering a soldering area arranged at the first end of the shielding assembly to corresponding soldering pads of the PCB.

### BRIEF DESCRIPTION OF THE DRAWINGS

The invention will be described in more detail with reference to the appended drawings. In the drawings:

FIG. 1 shows an exploded view of components of a configuration of an electrical interface;

FIGS. 2a and 2b shows perspective views of configurations of an electrical interface;

FIGS. 3a, 3b and 3c shows steps of a method of mounting an electrical interface to a PCB;

FIG. 4 shows a step of a method of mounting an electrical interface to a PCB;

FIGS. 5a and 5b shows perspective views of two variations of a shielding component of an electrical interface;

FIGS. 6a and 6b shows perspective views of configurations of an electrical interface; and

FIG. 7 shows a perspective view of a detail of a shielding component.

### DETAILED DESCRIPTION OF THE INVENTION

In the Figures, like reference numerals will be used for like features.

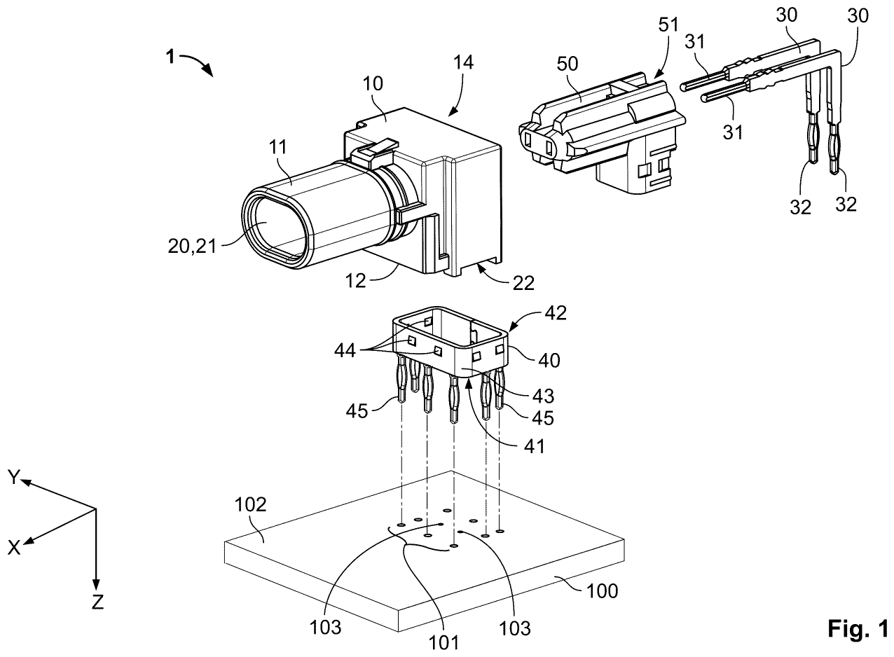

Turning to FIG. 1, an electrical interface for data connectivity is shown at 1, and a printed circuit board (PCB) is shown at 100. The electrical interface will also be referred to as header 1 in the following.

Header 1 in the depicted configuration is a surface-mount device (smd) which includes two electrical contacts 30 which are configured to make contact with printed circuits on the PCB 100 which are not shown in the figure. To this end, the electrical contacts 30 include second contact ends 32 which are configured as press-fit contacts which can be inserted in corresponding contact through-holes 103 in the PCB arranged in the printed circuits.

First contact ends 31 of the electrical contacts 30 are provided at a mating end 11 of a first housing 10 which mating end 11 defines a mating geometry for interconnection with an electrical plug assembly. For signal quality, the first housing 10 of the header 1 is electrically connected to ground via respective contacts provided in the PCB 100, for example via shielding through-holes 101 which will be described in greater detail below.

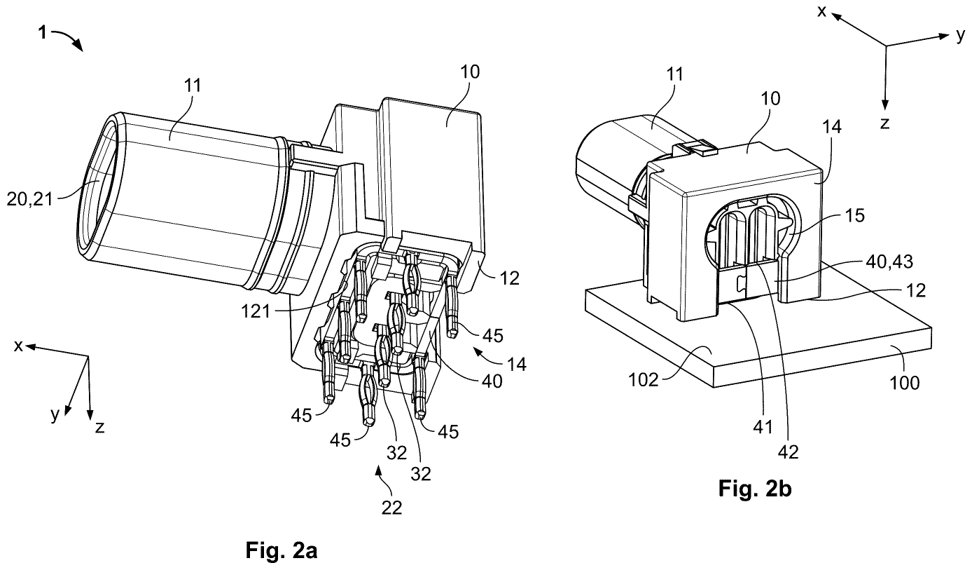

The electrical contacts 30 are electrically insulated from each other and from the first housing 10 by means of a second housing 50 which may comprise a dielectric. FIGS. 2a and 2b show the assembled header 1. By consideration of FIGS. 1 and 2, the skilled reader will appreciate that the electrical contacts 30 may be introduced into the second housing 50 from an open rear side 51 thereof, which in the assembled configuration shown is located at an end of the second housing 50 distal to the mating end 11 of the first housing 10.

Similarly, the pre-assembled second housing 50 and electrical contacts 30 may be inserted into the first housing 10 from a back side 14 thereof, which defines an opening 15 for this purpose. Alternatively, the second housing 50 may be introduced into the first housing 10 via opening 15 before the electrical contacts 30 are inserted into the second housing 50 via the open rear side 51 of the second housing 50.

The first housing 10 comprises a first opening 21 at the mating end 11 for allowing counter contacts of a corresponding plug assembly to make electrical contact with the first ends 31 of electrical contacts 30. A chamber 20 extends between the first opening 21 and a second opening 22 arranged at a bottom end 12 of the first housing 10, which is where the second ends 32 protrude from the housing 10 and connect to the PCB 100 via the contact through-holes 103. The chamber 20 accommodates the second housing 50 and the electrical contacts 30, thereby providing electric shielding of the electrical contacts 30 in multiple directions.

The Figures show configurations in which the mating end 11 and the bottom end 12 are arranged at sections of the first housing 10 that define a right angle between them. In FIG. 1, for instance, the mating end 11 is oriented along an x-axis, or x-direction, of the cartesian coordinate system shown in the figure, while the bottom end 12 is oriented along a z-axis, or z-direction, of the coordinate system. Irrespective thereof, there are configurations in which the mating end 11 and the bottom end 12 are oriented along a straight line, for example, along the z-axis, and the electrical contacts 30 are also formed as straight contact pads instead of the bent ones shown in the Figures.

Header 1 further comprises a shielding assembly 40 which among other things is configured to establish an electrical connection between the first housing 10 and the PCB 100. To this end, shielding assembly 40 comprises a first end 41 configured to be mounted to PCB 100, and a second end 42 configured to slidably engage within the bottom end 12 of the first housing 10. The term “slidably engage” in this context is meant to define that the second end 42 of the shielding assembly 40 and the bottom end 12 of the first housing exhibit frictional surface contact at least in certain parts of the two components in the assembled state. In the configuration shown in FIG. 1, slidable engagement between the shielding assembly 40 and the second opening 22 occurs along the z-direction.

The first end 41 of the shielding assembly 40 is configured to be connected to ground contacts provided on the mounting surface 102 of the PCB 100. In configurations in which the first housing 10 and the shielding assembly 40 are at least partially or completely manufactured from electrically conductive material, the slidable engagement of the first housing 10 and the shielding assembly 40 therefore also creates an electrically conductive connection between these two components. In other words, the first housing 10 is in these configurations electrically connected to ground via the shielding assembly 40.

In the configurations shown in the figures, the second opening 22 of the first housing 10 is configured to receive the second end 42 of the shielding assembly 40 in a press-fit manner. Therefore, the second opening 22 has a shape in a plane perpendicular to a mating direction of the first housing 10 and the shielding assembly 40, which in FIG. 1 is the z-direction, that is similar to a corresponding shape of the shielding assembly 40. In the configuration shown in the Figures, this shape is a substantially rectangular shape, as a result of the rectangular ground area of the first housing 10.

The size of the corresponding shape of the shielding assembly 40 and the size of the second opening 22 are configured such that press-fit occurs at least in some locations of interior surfaces 121 of the first housing 10 adjacent the second opening 22.

In the configurations shown in the figures, the shielding assembly 40 comprises a closed circumferential wall 43 extending along the mating direction, which in the figures is the z-direction, between the first end 41 and the second end 42. To facilitate of enhance the press-fit contact, the shielding assembly 40 comprises at least protrusions 44 in the circumferential wall 43, which may be created by an embossing process. The protrusions 44 protrude in a wedge-like manner perpendicular to the mating direction or z-direction from the circumferential wall 43, and are configured to mechanically engage with the interior surface 121 of the bottom end 12.

In other configurations, the protrusions may alternatively or additionally be provided at the interior surface 121 of the first housing 10 and configured to mechanically engage with the circumferential wall 43 of the shielding assembly 40.

As can be seen in e.g. FIG. 2b, the closed circumferential wall 43 extends around the second housing 50, thereby effectively providing a circumferential electrical shielding of the electrical contacts 30 in addition to the first housing 10, and thus enhancing signal quality of the header 1.

The header 1 defined in the foregoing comprises a housing design that effectively composed of two housing components which may be used to provide electrical shielding 40, namely the first housing 10 and the shielding assembly 40. The electrically conductive connection between the two components is achieved by means of the sliding engagement defined above, which in configurations may be a press-fit connection. This design facilitates header geometries and material combinations which cannot be achieved with header designs of the prior art, and allows for advantageous methods of mounting the header 1 to the PCB 100. At least some of these aspects and advantages will be pointed out in the following.

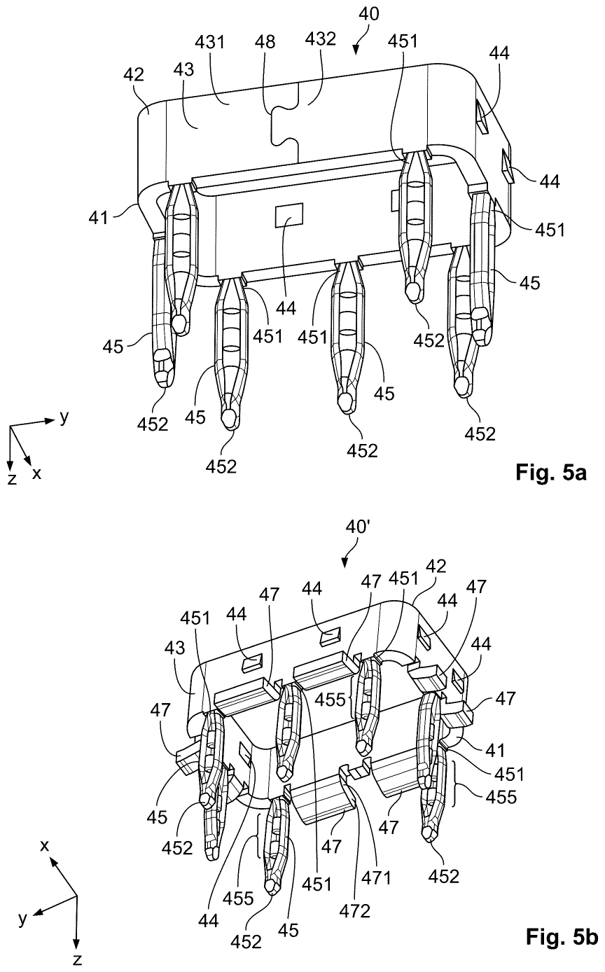

In the configuration shown in FIG. 1, the shielding assembly 40 comprises a plurality of contact pins 45 extending from the first end 41 and configured for insertion into and frictional engagement with the shielding through-holes 101 in the PCB 100. This configuration is shown in more detail in FIG. 5a. As may be seen in the figure, the contact pins 45 are evenly spaced along the circumference of the circumferential wall 43.

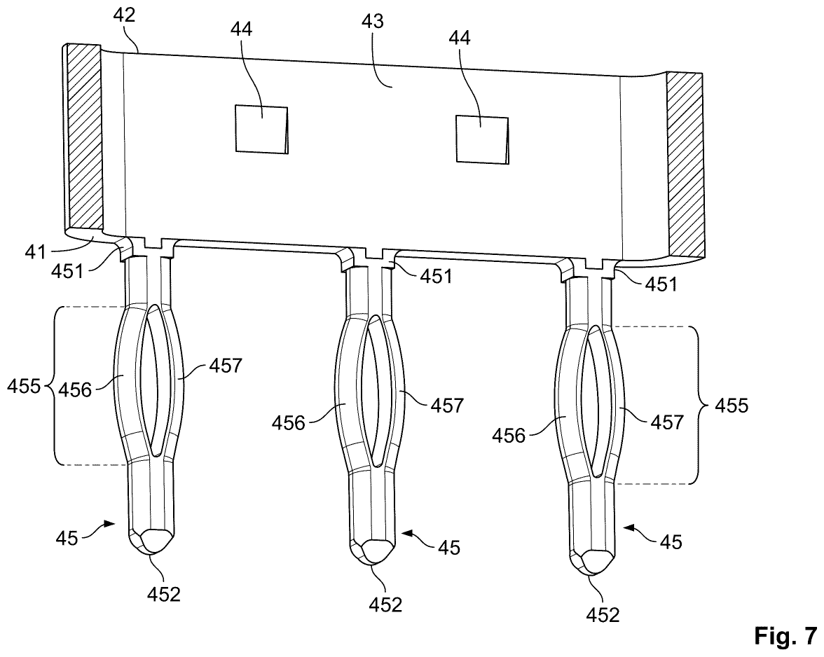

Each one of the contact pins 45 extends linearly along the mating direction, or z-direction, between a first pin end 451 attached to the circumferential wall 43 of the shielding assembly 40 and a second pin end 452 distal from the first pin end 451. An elastic press-fit portion 455 which may best be seen in FIG. 7 extends symmetrical between the first pin end 451 and the second pin end 452. The press-fit portion 455 is configured interact with the walls of the corresponding shielding through-hole 101 to firmly secure the respective contact pin 45 within the shielding through-hole 101. In the configuration of FIG. 7, the press-fit portion 455 comprises displaceable contact arms 456, 457 which extend in opposite directions from each other and perpendicular to the mating direction. The diameter of the press-fit portion 455 in relation to the diameter of the corresponding shielding through-hole 101 is such that elastic deformation of the contact arms 456, 457 of the press-fit portion 455 occurs during insertion of the contact pin 45 into the corresponding shielding through-hole 101 and makes insertion possible.

In this configuration, the shielding assembly 40 may be manufactured from one continuous piece of metal, by cold-forming steps such as cutting, punching, folding, coining, and bending a metal blank. As indicated in FIG. 5a, the circumferential wall 43 may include a seam portion 48 at which two ends 431, 432 of the metal strip forming the circumferential wall 43 are interlocked to form the closed geometry of the circumferential wall 43. As shown in FIG. 5a, a puzzle-shaped interlocking geometry 48 of the two ends 431, 432 may be formed to this end, for example by means of a punching process.

The metal used for the shielding assembly 40 may comprise, for example, a bronze alloy, for instance of the CuSn6 or CuNiSi family, which exhibits material properties suited to elastic deformation of the contact pins 45. As an advantageous result of the design of the header 1 defined in the above, the material of the first housing 10 may be chosen to be different from the material of the shielding assembly 40. For instance, in configurations of the header 1, the first housing 10 is manufactured as a die-cast part using suitable materials other than the above-mentioned elastic steel varieties used for the shielding assembly 40. Die-casting the first housing 10 allows for a cost-efficient way of providing the first housing 10 in the shape desired, for example with regard to the mating geometry of the mating end 11, and the chamber 20.

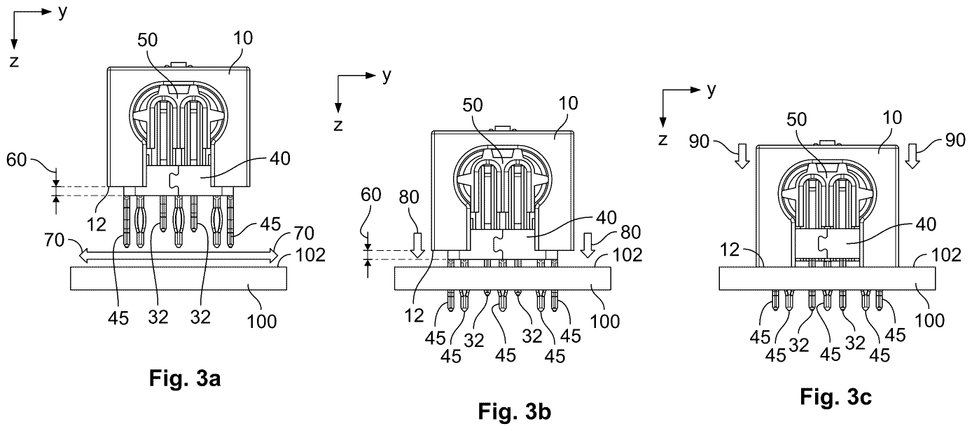

A method of mounting the header 1 to the PCB 100 will be described in the following under reference to FIG. 3. A step S1 comprises providing the first housing 10 as defined above, and a step S2 comprises providing the shielding assembly 40 as specified above. In a step S3b, the shielding assembly 40 is mounted to the PCB 100 by sliding the first housing 10 over the shielding assembly 40 in the area of the second opening 22 as discussed above. Note that in the configuration shown in FIG. 3a, there is a circumferential gap 60 between the edge delimiting the bottom end 12 of the first housing 10 and the edge delimiting the first end 41 of the shielding assembly 40. In other words, in the step S3b according to the configuration shown in FIG. 3a, the press-fit and electrical contact between the first housing 10 and the shielding assembly 40 is only partially established.

The step S3b may also comprise the steps of mounting the second housing 50 and the electrical contacts 30 to the header 1, as discussed above. The header 1 can then be adjusted in position above the PCB 100 as indicated by the horizontal arrows 70 in FIG. 3a.

In a step S4b shown in FIG. 3b, the header 1 comprising at least the first housing 10 and the shielding assembly 40 are then mounted to the PCB 100 by inserting the contact pins 45 into the corresponding shielding through-holes 101. The force acting on the header 1 to insert the contact pins 45 into the shielding through-holes 101 is represented by the arrows 80 aligned along the mating direction z.

In a method step S4c indicated in FIG. 3c, a force represented by arrows 90 is applied in mating direction z on the first housing 10 to push the first housing 10 further along the mating direction z, while the shielding assembly 40 is already in its final position on the mounting surface 102 of the PCB 100. As a consequence, the first housing 10 slides further over the shielding assembly 40 until the bottom end 12 makes contact with the mating surface 102, thereby reliably closing the gap 60 irrespective of any manufacturing tolerances of any of the first housing 10 and/or the shielding assembly 40.

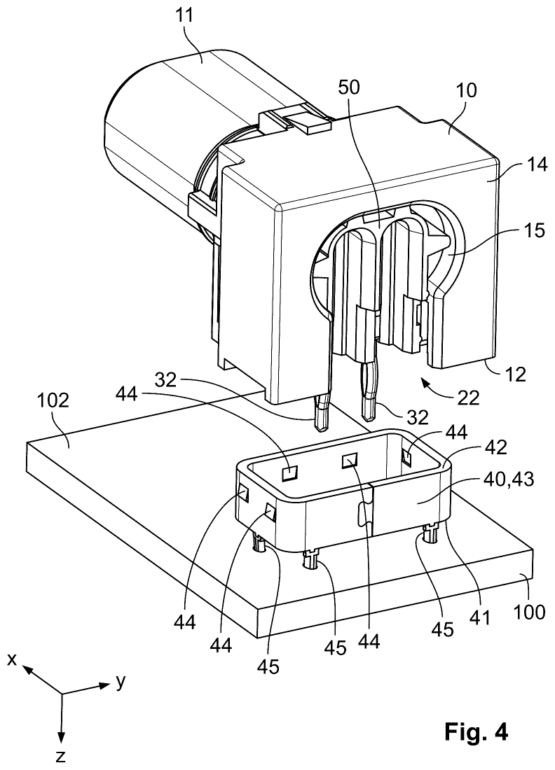

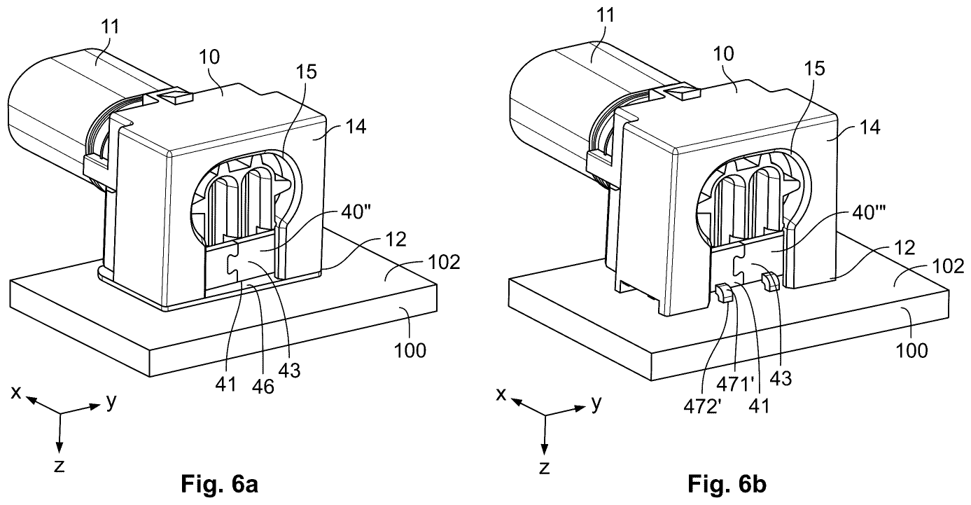

In an alternative mounting method shown in FIG. 4, steps S1 and S2 of providing the first housing 10 and the shielding assembly 40 correspond to what has been disclosed in relation to FIG. 3. Method step S3a, however, which is shown in FIG. 4, comprises mounting the shielding assembly 40 to the PCB 100 without prior mounting the first housing 10 to the shielding assembly 40. In this configuration, only the shielding assembly 40 is mounted to the PCB 100. The step S3a may comprise the step of pressing the contact pins 45 provided on the shielding assembly 40 in the corresponding shielding through-holes 101 of the PCB 100. In other configurations of the shielding assembly 40 discussed further below with reference to FIG. 6, the shielding assembly 40 may not include contact pins 45 and may be positioned on the PCB 100 by means of other techniques such as soldering.

Irrespective of whether the shielding assembly 40 does include contact pins 45 or not, in the configuration where the shielding assembly 40 is positioned on the mounting surface 102 of the PCB 100, this assembly may be joined by means of soldering, for example in a soldering furnace. It is advantageous in this context that the height of the shielding assembly 40 in a direction perpendicular to the mounting surface 102 of the PCB 100, i.e. is the extension of the shielding assembly 40 along the z-axis in FIG. 4, is small compared to the extension of the final header 1 in this direction. Consequently, little room and head space is required in the soldering furnace for the mounting of the shielding assembly 40 to the PCB 100.

In a step S4a following steps S3a, the first housing 10 is mounted to the shielding assembly 40 by pressing it onto the shielding assembly 40 and establishing press-fit or at least frictional contact between the two parts, as discussed in the above. Step S4a may be applied irrespective of whether the step S3a included soldering the shielding assembly 40 to the PCB 100 or not.

The shielding assembly 40 comprises a soldering skirt 46 extending from the first end 41 of the circumferential wall 43, the soldering skirt 46 configured to extend parallel to a mounting surface 102 of the PCB 100 and to be soldered to corresponding soldering contacts of the PCB 100.

With reference to FIGS. 5b and 6, further variations of the shielding assembly 40 will be described in the following.

Both FIG. 5b and FIG. 6b show configurations in which the shielding assembly 40 comprises spring elements 47, 47′ extending from the first end 41 of the circumferential wall 43 in the mating direction z, which means substantially in the same direction as the contact pins 45. The spring elements 47, 47′ are configured to provide a pretension force between the circumferential wall 43 and the mounting surface 102 of the PCB 100 once the header 1 is mounted to the PCB 100. The pretension of the shielding assembly 40 against the mounting surface 102 minimises the likelihood of the header 1 being displaced along the mating direction as a result of e.g. vibrations, and thus helps establishing a high-quality signal transmission via the header 1.

In both the configuration of FIG. 5b and the one of FIG. 6b, each of the spring elements 47, 47′ comprise bent portions 471, 471′ adjacent the circumferential wall 43. In the configuration shown in FIG. 5b, the respective bent portions 471 are oriented such that flange portions 472 attached to the bent portion 471 extend substantially perpendicular to the mating direction z, which means parallel to the mounting surface 102 of the PCB 100 in the mounted state of the header 1. This way, the flange portions 472 may also be used as soldering points should soldering the shielding assembly 40 to the PCB 100 be desired.

In the configuration shown in FIG. 6b, the bent portions 471′ are oriented such that flange portions 472′ attached to the bent portions 471′ extend substantially parallel to the mating direction z, which means perpendicular to the mounting surface 102 of the PCB 100 in the mounted state of the header 1.

In both configurations, the bent portions 471, 471′ of the spring elements 47, 47′ is adapted to elastically deform under pressure in the mating direction and thus provides the pretension force. As mentioned in the foregoing with regard to the contact pins 45, the particular design of the header 1 disclosed in the foregoing allows for the selection of a suitable elastic and conductive material for the shielding assembly 40 and consequently of the spring elements 47, 47'.

In the configuration shown in FIG. 6a, the shielding assembly 40 comprises a circumferential soldering skirt 46 extending at substantially 90 degrees from the first end 41 of the circumferential wall 43. As mentioned in the foregoing with reference to the method of mounting the header 1 to the PCB 100, the configuration of the shielding assembly 40 shown in FIG. 6a may be used in method step S3a as an alternative to configurations comprising contact pins 45.

In a favourable alternative to methods known in the art, the shielding assembly 40 shown in FIG. 6a may be positioned on the PCB 100 and attached to same prior to assembly of the header 1, i.e. before the first housing 10 is mounted to the shielding assembly. Consequently, the dimensions and/or material of the first housing 10 do not impose any constraints on the soldering step. For example, it is not required for the first housing 10 to be have a weight distribution which results in the centre of gravity being above an area on the mounting surface 102 confined by the soldering skirt 46. Such restraints exist in the prior art when the complete header is to be soldered to the PCB, since the header would otherwise not sit flat on the mounting surface, and topple over.

As may be recognized by those of ordinary skill in the pertinent art based on the teachings herein, numerous changes and modifications may be made to the above-described and other embodiments of the nozzles of the present invention without departing from the scope of the invention as defined in the appended claims. Accordingly, this detailed description of currently preferred embodiments is to be taken in an illustrative, as opposed to a limiting sense.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical interface comprising:
a first housing including a chamber extending at least between a first opening arranged at a mating end of the first housing and a second opening arranged at a bottom end of the first housing, the mating end configured to receive a corresponding electrical plug connector;
at least one electrical contact extending within the chamber at least between the mating end and the bottom end, the at least one electrical contact being configured to electrically connect to corresponding plug contacts of the plug assembly; and
a shielding assembly including a first end configured to be mounted to a printed circuit board and a second end configured to slidably engage within the bottom end of the first housing.

2. The electrical interface according to claim 1, wherein the second opening of the first housing is configured to receive the second end of the shielding assembly in a press-fit manner.

3. The electrical interface according to claim 1, wherein the shielding assembly comprises a closed circumferential wall extending between the first end and the second end.

4. The electrical interface according to claim 3, wherein the shielding assembly comprises at least one protrusion embossed in the circumferential wall, the at least one protrusion being configured to mechanically engage with a corresponding at least one surface of the bottom end to establish a press-fit contact;
the first housing including at least one protrusion in at least one surface of the bottom end, the at least one protrusion being configured to mechanically engage with the circumferential wall of the shielding assembly to establish a press-fit contact.

5. The electrical interface according to claim 1, wherein the shielding assembly comprises a soldering skirt extending from the first end of the circumferential wall, the soldering skirt configured to extend parallel to a mounting surface of the PCB and to be soldered to corresponding soldering contacts of the PCB;
the soldering skirt extends at substantially 90 degrees from the first end of the circumferential wall.

6. The electrical interface according to claim 1, wherein the shielding assembly comprises at least one contact pin extending from the first end and configured for insertion into and frictional engagement with corresponding at least one shielding through holes in the PCB.

7. The electrical interface according to claim 6, wherein each one of the at least one contact pins comprises an elastic press-fit portion comprising displaceable contact arms which at least in sections extend in opposite directions from each other.

8. The electrical interface according to claim 6, wherein the circumferential wall extends along a substantially rectangular shape, and wherein the at least one contact pins are evenly distributed along at least three sides of the circumference of the rectangular shape.

9. The electrical interface according to claim 6, wherein the shielding assembly comprises at least one spring element extending from the first end of the circumferential wall, the at least one spring element configured to provide a pretension force between the circumferential wall and a mounting surface of the PCB when the electrical interface is mounted to the PCB.

10. The electrical interface according to claim 9, wherein the at least one spring element comprises a bent portion adjacent the circumferential wall, and a flange portion configured to extend parallel to a mounting surface of the PCB, or perpendicular to the mounting surface.

11. The electrical interface according to claim 10, comprising a plurality of the contact pins and a plurality of spring elements, wherein each spring element is arranged between two contact pins;
the shielding element being manufactured from one continuous piece of metal.

12. The electrical interface according to claim 11, comprising a second housing arranged in the chamber and at least partially enclosing the at least one electrical contact, the second housing being configured to electrically insulate the at least one electrical contact.

13. A method of mounting an electrical interface to a printed circuit board, the method comprising the steps of:
S1—providing a first housing comprising a chamber extending at least between a first opening arranged at a mating end of the first housing, and a second opening arranged at a bottom end of the first housing;
S2—providing a shielding assembly comprising a first end configured to be mounted to the PCB, and a second end configured to slidably engage within the bottom end of the first housing;
selectively:
S3a—mounting the shielding assembly to the PCB; and
S4a—sliding the first housing onto the shielding assembly;
Or
S3b—sliding the first housing onto the shielding assembly; and
S4b—mounting the shielding assembly and the first housing onto the PCB.

14. The method of claim 13, wherein:
Step S3a comprises the step of soldering a soldering area arranged at the first end of the shielding assembly to corresponding soldering pads of the PCB; and/or
Step S3a comprises the step of pressing at least one contact pin provided on the shielding assembly in a corresponding shielding through hole of the PCB.

15. The method of claim 13, wherein:
Step S3a comprises the step of pressing at least one contact pin provided on the shielding assembly in a corresponding shielding through hole of the PCB; and/or
Step S4b comprises the step of soldering a soldering area arranged at the first end of the shielding assembly to corresponding soldering pads of the PCB.
